(19) United States
(12) Patent Application Publication
(10) Pub. No.: US 2005/0195096 A1
(43) Pub. Date: Sep. 8, 2005

(54) Rapid mobility analysis and vehicular route planning from overhead imagery

(76) Inventors: Derek K. Ward, Arlington, TX (US); Margaret K. Walloch, Arlington, TX (US)

Correspondence Address: WILLIAMS, MORGAN & AMERSON, P.C., 10333 RICHMOND, SUITE 1100, HOUSTON, TX, 77042, US

(21) Appl. No.: 10/794,361

(22) Filed: Mar. 5, 2004

(51) Int. Cl. G01C 21/32

(52) U.S. Cl. 340/995.14

(57) ABSTRACT

The invention comprises, in its various embodiments and aspects, a method and apparatus for generating a dynamic mobility map. The method includes classifying a plurality of objects represented in a data set comprised of overhead imagery data; and classifying the objects through application of dynamic data pertaining to those objects. The apparatus includes a program storage medium encoded with instructions that, when executed by a computing device, perform such a method and a computing apparatus programmed to perform such a method. The method, in alternative embodiments, may be employed in generating dynamic mobility maps and in association with a ground vehicle to operate the vehicle or simulate the operation of the vehicle.

### BACKGROUND OF THE INVENTION

1. Field of the Invention

This invention pertains to ground vehicle mobility and, more particularly, to a method and apparatus for navigating a ground vehicle.

2. Description of the Related Art

The mobility of ground vehicles, and particularly unmanned ground vehicles (“UGVs”), may be limited by many factors. One significant factor is “situational awareness.” Situational awareness includes detection and identification of conditions in the surrounding environment. Robotic vehicles, for example, typically carry a variety of instruments to remotely sense the surrounding environment. Commonly used instruments include technologies such as:
acoustic;
infrared, such as short wave infrared (“SWIR”), long wavelength infrared (“LWIR”), and forward looking infrared (“FLIR”);
optical, such as laser detection and ranging (“LADAR”).
   This list is not exhaustive, and a variety of technologies may be employed. Sometimes, several different technologies may be employed since each has benefits and disadvantages relative to the others.

Two interrelated factors, with respect to traversing terrain, are navigation and obstacle negotiation. One integral part of obstacle negotiation is obstacle recognition, or “identification.” Any given obstacle must first be detected and identified before an appropriate negotiation strategy can be adopted. For instance, a negative obstacle (a ditch, for example) may be negotiated differently from a positive obstacle (e.g., a wall or barrier). For a further example, an obstacle identified as tall grass may be traversed differently from an obstacle identified as a low wall. Thus, the successful selection of a negotiation strategy begins with the accurate identification of the obstacle. The identification is usually made by computing systems operating on data remotely sensed by sensors aboard the vehicle. Obstacle identification is also important to navigation.

To navigate, the vehicle must select a path through known obstacles. This is known as “route planning.” Human cognition of obstacles and identification of paths through obstacles is exceedingly difficult to replicate with computers. Even with remotely operated vehicles, where a driver actively selects a route, high performance can be hampered by a general inability to accurately present to the driver the current situation in which the vehicle is operating. Consider, for example, where the driver is presented with information indicating that the vehicle's current path is obstructed by vegetation. The nature of the vegetation, e.g., whether it is tall grass or more substantial brush, may greatly influence the decision on whether to modify the route. In good conditions and with video data presented to the driver, the decision may not be difficult. However, in adverse conditions or without good quality video, the decision may be more difficult.

A number of efforts have been undertaken to address develop techniques for accurately identifying obstacles and routes from data acquired through remote sensing technologies. Remote sensing technologies can be deployed in systems that may be characterized by their mode of operation. For instance, commonly encountered modes of operation include:
a passive mode, i.e., the detected radiation emanates from within the environment;
an active mode, i.e., the detected radiation is first introduced into the environment by the system that detects it; and
semi-actively, i.e., the detected radiation is first introduced into the environment by a system other than the one that detects it.
   Some of these technologies (e.g., LADAR) can be used in multiple modes.

However, data acquisition is just one part of this effort. The acquired data is analyzed to identify features of interest—for example, obstacles. To a significant degree, the analysis will depend on the technology but not its mode of acquisition. Thus, LADAR data may be processed differently than infrared data, but the processing will be similar for LADAR data that was acquired actively versus data that was acquired semi-actively. One important characteristic in the application is whether the acquired data is two-dimensional (e.g., infrared data) or three-dimensional (e.g., LADAR data). The data processing will typically attempt to analyze the data, according to the type of data, to extract characteristics of various objects. For instance, in a LADAR system, the data may be processed to extract the height, width, depth, and reflectivity of an object, from which an object identification is attempted.

Mobility of military vehicles, in particular, presents additional problems. Military vehicles are frequently expected to traverse unimproved terrain that may include large numbers of random obstacles. Furthermore, conditions may change rapidly as combat obliterates or changes the nature of a given obstacle. A bridge over a large river, for instance, may be destroyed while the vehicle's route is under consideration. Still further, some obstacles, e.g., land mines, are actually hidden. Another hazard common in military applications is hostile enemy fire. Thus, in navigation, route planning must consider threats to the vehicle and its occupants (if any). Even if information can be presented to a driver, the driver has comparatively little time to make a decision before potentially compromising the safety of his men and/or the survivability of the vehicle.

Military mobility analysis, as currently conducted, generally relies on static terrain maps in the hands of an observer who marks or colors regions of the map that represent GO/NOGO areas. Recent efforts have produced dynamic mobility maps, usually of limited size and resolution, that may be annotated for the same GO/NOGO information and then disbursed electronically to hand held electronic devices. Neither of these methods offers a comprehensive and dynamic mobility map encompassing an entire area of operation. Current ground conditions, ground water content, highly dynamic obstacles and a myriad of other local data, which are critical to the actual ability of a vehicle to negotiate in a dynamic battlefield, are absent. This dynamic data, which impacts mobility, is currently ignored, unaccounted for, or at best reported on an ad hoc basis. Conventional static mobility maps, and the rudimentary dynamic mobility maps based on static terrain assumptions, rapidly become invalid due to changes in weather, snow/moisture conditions, direct/indirect fires, and threat combat engineering efforts.

A vehicle on a battlefield must have routes, from the route-planning capability, that successfully negotiates threat positions, avoids battlefield obstacles, adheres to a mission timeline and accounts for weather and other dynamic effects on the terrain. Current military vehicle operations, for manned combat vehicles, require the vehicle's operator to integrate all these elements from static maps, threat reports, weather reports, and whatever he can pick up from the radio. After determining his route, he then must audibly coach the driver to accomplish his desired mission. All too often, he must make these decisions and assist the driver while also busy fighting, commanding the vehicle, or in communication.

Route planning for unmanned vehicles is currently dependent on having onboard sensors that can observe both close and distant terrain. These terrain images are either processed on board by tracking against waypoints and comparing against the expected terrain, or they are relayed to an operator for further navigation instructions. Current route planning is based on static maps with no dynamic data considered in onboard processing, and for the off-board processing, the operator must rely on the same ad hoc method described for the driver in the case of manned vehicles.

The present invention is directed to resolving, or at least reducing, one or all of the problems mentioned above.

### SUMMARY OF THE INVENTION

The invention comprises, in its various embodiments and aspects, a method and apparatus for generating a dynamic mobility map. The method includes classifying a plurality of objects represented in a data set comprised of overhead imagery data; and classifying the objects through application of dynamic data pertaining to those objects. The apparatus includes a program storage medium encoded with instructions that, when executed by a computing device, perform such a method and a computing apparatus programmed to perform such a method. The method, in alternative embodiments, may be employed in generating dynamic mobility maps and in association with a ground vehicle to operate the vehicle or simulate the operation of the vehicle.

### BRIEF DESCRIPTION OF THE DRAWINGS

The invention may be understood by reference to the following description taken in conjunction with the accompanying drawings, in which like reference numerals identify like elements, and in which:

FIG. 1 depicts a ground vehicle constructed and operated in accordance with one particular embodiment of the present invention and the acquisition of overhead imagery data;

FIG. 2 depicts, in a block diagram, selected portions of a computing apparatus with which certain aspects of the present invention may be implemented;

FIG. 3 illustrates an imagery analysis in accordance with the present invention performed on the overhead imagery data acquired as shown in FIG. 1;

FIG. 4 illustrates one particular embodiment of a portion of the analysis in FIG. 3;

FIG. 5 conceptually illustrates the structure and performance of the dynamic map generator of the computing apparatus shown in FIG. 2;

FIG. 6 depicts an exemplary image of a given terrain;

FIG. 7 depicts the exemplary image of FIG. 6 after a first level of object classification in accordance with one particular embodiment of the present invention;

FIG. 8 depicts the exemplary image of FIG. 6 after a second level of object classification in accordance with one particular embodiment of the present invention;

FIG. 9 depicts an exemplary image after a third level of object classification in accordance with one particular embodiment of the present invention;

FIG. 10 depicts the exemplary image of FIG. 6 after a fourth level of object classification in accordance with one particular embodiment of the present invention;

FIG. 11 and FIG. 12 depict the exemplary image of FIG. 6 after a fifth level of object classification in accordance with one particular embodiment of the present invention;

FIG. 13 and FIG. 14 depict the exemplary image of FIG. 6 after a fifth level of object classification in accordance with one particular embodiment of the present invention;

FIG. 15 and FIG. 16 depict the exemplary image of FIG. 6 after a sixth level of object classification in accordance with one particular embodiment of the present invention;

FIG. 17 and FIG. 18 illustrate the automatic pull and processing of metadata from the tactical network first shown in FIG. 5;

FIG. 19 and FIG. 20 depict the exemplary image of FIG. 6 after a fifth level of object classification in accordance with one particular embodiment of the present invention;

FIG. 21 conceptually illustrates the export of a processed image to a second terrain database format;

FIG. 22 conceptually illustrates the export of a processed image to a first terrain database format;

FIG. 23 depicts an exemplary operator interface for the route planner of the embodiment in FIG. 1;

FIG. 24 illustrates the interaction between the route planner and the operator interface in the embodiment of FIG. 1;

FIG. 25 illustrates an alternative embodiment in which the present invention is employed in a simulator; and

FIG. 26 illustrates an alternative embodiment in which the present invention is employed in a distributed, integrated simulation environment.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

FIG. 1 depicts a ground vehicle 100 constructed and operated in accordance with one particular embodiment of the present invention. The ground vehicle 100 is, in the illustrated embodiment, an unmanned ground vehicle (“UGV”), although the invention is not so limited. The ground vehicle 100 is controlled by an operator 102 using an operator control unit (“OCU”) 104 over a wireless communications link 106. An overhead platform 108 acquires overhead imagery data (not shown in FIG. 1) that is transmitted to a data processing facility 109 over a wireless communications link 110. The overhead imagery data is then provided to the ground vehicle 100 in a manner described more fully below. The overhead platform 108 is, in the illustrated embodiment, a satellite 112 but may be, in alternative embodiments, an airborne vehicle, such as the aircraft 114, or an unmanned airborne vehicle (“UAV”), such as a PREDATOR™ reconnaissance drone manufactured by Lockheed Martin Corporation.

Note that, although the ground vehicle 100 in the illustrated embodiment is unmanned and remotely operated by the operator 102, the invention is not so limited. The present invention may be applied to manned vehicles in which the operator 102 rides in the vehicle and drives over a mechanical linkage or drive-by-wire system. Furthermore, some aspects of the invention can be implemented in autonomous, robotic vehicles in which the operator 102 directs an appropriately programmed, digital computing system to operate the vehicle. Note also that, in some embodiments, the ground vehicle 100 carries a sensor package payload 111. The sensor package payload 111 permits the ground vehicle 100 to acquire data promoting the situational awareness of the ground vehicle 100.

The ground vehicle 100, operator 102, overhead platform 108, and data processing facility 109 are shown in fairly close proximity. However, the invention is not so limited. Since the communications are wireless, the ground vehicle 100, operator 102, overhead platform 108, and data processing facility 109 may be separated by distances permitted by the capabilities of the transmitter of the OCU 104. Note that the wireless communications may be facilitated by, for example, satellite relay to extend such distances beyond line-of-sight.

As previously mentioned, the overhead platform 108 acquires overhead imagery data and transmits it wirelessly to the data processing facility 109. In the illustrated embodiment, the overhead imagery data comprises one or more of black and white panchromatic data, red-green-blue data, and/or near infrared (“IR”) multispectral data. Some embodiments may also employ radar and/or laser altimeter data for greater accuracy in surface roughness calculations. Any suitable kind of overhead imagery data may be employed. The remote sensing technology with which the overhead imagery data is obtained is not material to the practice of the invention, nor is the mode by which it is acquired. The overhead imagery data may be acquired actively, as indicated by the arrow 116, semi-actively, or passively, as indicated by the arrow 118, depending on the implementation. As will be appreciated by those skilled in the art having the benefit of this disclosure, certain kinds of platforms are more suited to certain types of acquisition or acquiring certain types of imagery data.

In the illustrated embodiment, the OCU 104 is a lightweight, man portable, hand-held and wearable unit remote from the ground vehicle 100 (and out of harm's way). The OCU 104 connects to the ground vehicle 100 via the wireless communications link 106, which, in the illustrated embodiment, is a military RF command link 106. It includes remotely operated capability as well as data display, storage, and dissemination. The OCU 104 also:
encompasses standard interfaces for versatility and future expandability;
conforms with military specifications regarding temperature, humidity, shock, and vibration;
allows the operator 102 to independently tele-operate single or multiple ground vehicles 100;
uses standard military symbology to display location, movement, and status of friendly, hostile, and unknown units; represents terrain maps and nuclear, biological, and chemical (“NBC”) assessments using the military grid reference system; and
can provide auditory feedback for system status or relaying information from acoustic sensors onboard.
   A secondary fiber optic link can be used when RF signals are undesirable. Exemplary, off-the-shelf units with which the OCU 104 may be implemented include FBI-Bot, AST, RATLER, DIXIE, SARGE, and TMSS.

More particularly, the OCU 104 allows the operator 102 to independently tele-operate single or multiple ground vehicles 100. A map display is updated in real-time with current data from the ground vehicle fleet (only one shown). Standard military symbology, such as found in MIL-STD-2525B, displays the location, movement and status of friendly, hostile, and unknown units on the map display. Vehicle status is displayed continually beside the unit icons and optionally with a popup display of more detailed status information. Sensory data from the NBC detector and other sensory payloads of the ground vehicle 100 are overlaid on the map display. Laser range finder and optical sensor gaze direction are represented on the display as a line radiating from the ground vehicle icon. The terrain maps and NBC assessments are represented using the military grid reference system. Auditory feedback can be provided for system status or relaying information from acoustic sensors onboard the ground vehicle.

Remote operation of a single ground vehicle 100 can be done with a first-person perspective view through use of real-time video and a pointing device to control vehicle course and speed. Remote management of a single or multiple ground vehicles 100 can be accomplished via manipulating the corresponding vehicle icons on the map to set destination objectives and paths in accordance with the present invention. The real time video display can optionally be zoomed to fill the display with overlaid vehicle status appearing in a heads-up display (“HUD”). Multiple ground vehicles 100 can be controlled via mission orders issued by manipulating the vehicle fleet icons on the map display or by issuing high-level commands, such as to surround a particular objective or to avoid a particular area while moving autonomously in accordance with the present invention.

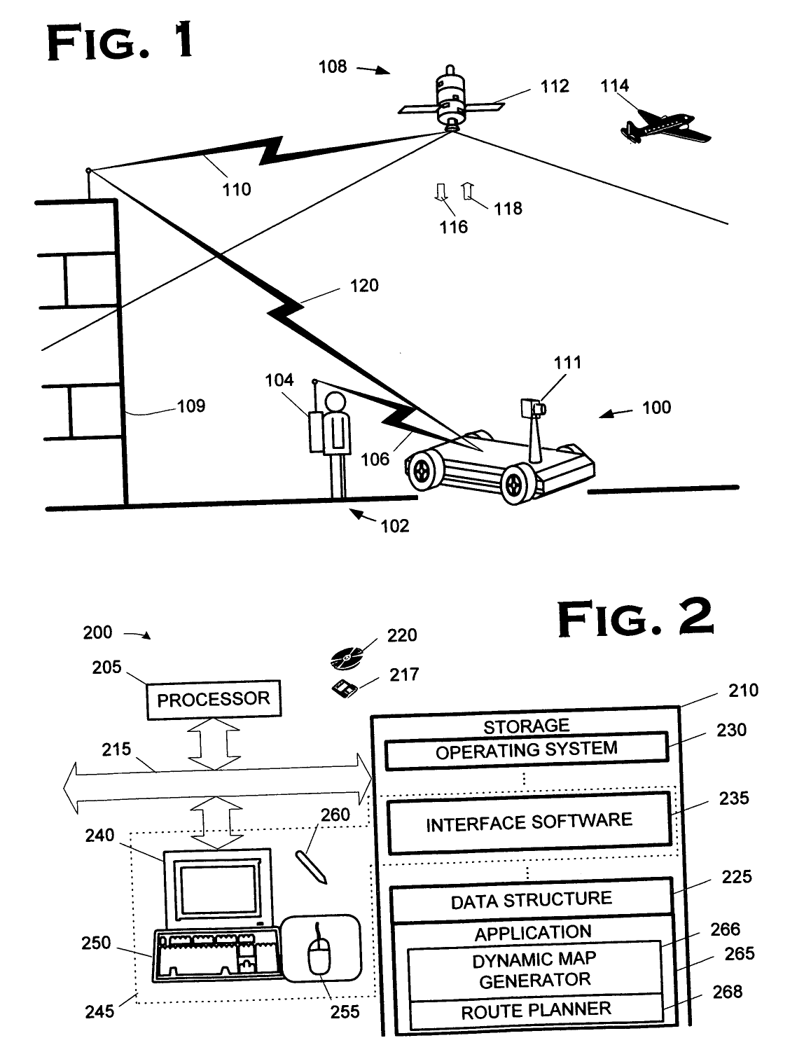

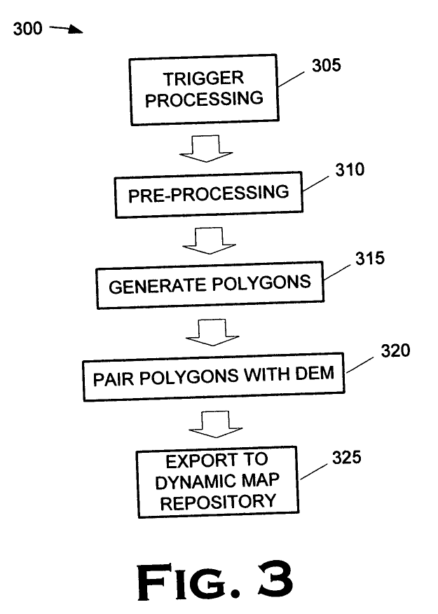

The ground vehicle 100 is also equipped with a rack-mounted computing apparatus 200, conceptually illustrated in the block diagram of FIG. 2. The computing apparatus 200 includes a computing device, e.g., a processor, 205 communicating with some storage 210 over a bus system 215. The storage 210 may include a hard disk and/or RAM and/or removable storage such as the magnetic disk 217 and the optical disk 220. The storage 210 is encoded with one or more data structures 225, at least one of which is capable of buffering, or storing, the overhead imagery data acquired as discussed above during processing.

The storage 210 is also encoded with an operating system 230 and interface software 235 that, in conjunction with a display 240, constitute an operator interface 245. The display 240 may be a touch screen allowing the operator 102 to input directly into the computing apparatus 200. However, the operator interface 245 may include peripheral I/O devices such as a keyboard 250, a mouse 255, or a stylus 260, for use with other types of displays, e.g., a HUD. Note that, in the illustrated embodiment, the display 240 and peripheral devices 250, 255, and 260 form a part of the OCU 104, shown in FIG. 1, and are not mounted to the ground vehicle 100. However, in alternative embodiments, they may be mounted to the ground vehicle 100. The computing device 205 runs under the control of the operating system 230, which may be practically any operating system known to the art. The computing device 205, under the control of the operating system 230, invokes the interface software 235 on startup so that the operator 102 can control the computing apparatus 200.

The storage 210 is also encoded with an application 265 invoked by the computing device 205 under the control of the operating system 230 or by the operator 102 through the operator interface 245. The application 265, when executed by the computing device 205, processes the overhead imagery data buffered in a data structure 225 in accordance with the invention, as discussed more fully below. The application 265 also displays data and information to the operator 102 on the display 240. In general, the application 265 comprises a dynamic map generator 266 and a route planner 268.

The dynamic map generator 266 rapidly and automatically generates mobility maps from the overhead imagery data. The dynamic mobility maps reflect the real time or near real time battlefield conditions, weather implications, roads, road types and road conditions, soil type, surface roughness, water bodies, vegetation data, man made objects, and land use. Large or small areas may be rapidly analyzed following the rules-based architecture presented herein for road networks, populated areas, forest areas, cultivated and non-cultivated areas, and attributes of the defined areas.

In general, the overhead imagery data comprises what may also be known as “photogrammetric” data. “Photogrammetry” is the science of making reliable measurements by the use of images, especially aerial images. One type of photogrammetric process produces three-dimensional graphic images from two-dimensional aerial images. The two-dimensional images are typically obtained from an airplane or a reconnaissance satellite. There are many well-known techniques for accomplishing this task.

Data for generating photogrammetric imagery is typically stored in large databases. The two-dimensional data is frequently indexed within the database by the position from which it is acquired. The position is expressed in terms of latitude and longitude. Elevational data is similarly indexed by position in another database. As part of the photogrammetric process, two-dimensional data is combined with elevational data. When the latitudinal, longitudinal, and elevational data is combined with an observation point and an orientation, realistic three-dimensional view of the environment can be displayed.

The photogrammetric imagery may be overlaid with additional information to enhance its usefulness, as will be discussed further below. For instance, the imagery can be overlaid with visual representations of surrounding vehicular traffic or cultural features such as buildings. Also, the photogrammetric imagery can be manipulated for presentation in certain formats, such as a HUD, or as seen through certain instruments such as night vision goggles. Many such features might be added to various embodiments to enhance their utility for certain applications.

This type of photogrammetric imagery is now commercially available from several sources and has many uses because it accurately depicts a real environment in three-dimensions. In the illustrated embodiment, the photogrammetric imagery data is developed a priori, either using proprietary systems or from commercially available sources. The photogrammetric imagery data is then stored in the data structure 225. Given the voluminous nature of the photogrammetric imagery data, this portion of the data structure 225 will typically be read-only and encoded in an optical medium, i.e., a CD-ROM. Again, any suitable data structure known to the art may be used.

Note that photogrammetric imagery data is relatively voluminous by nature. The implementation of the computing apparatus 200 will therefore significantly impact any particular embodiment of the invention. Thus, some kinds of computing devices are more desirable than others for implementing the computing device 205 than others. For instance, a digital signal processor (“DSP”) or graphics processor may be more desirable for the illustrated embodiment than will be a general purpose microprocessor. The Onyx® VTX R4400 and/or R10000 graphics processors available from Silicon Graphics, Inc. and associated hardware (not shown) may be suitable for the illustrated embodiment, for instance. Other video handling capabilities might also be desirable. For instance, a joint photographic experts group (“JPEG”) or other video compression capabilities and/or multi-media extensions may be desirable. In some embodiments, the computing device 205 may be implemented as a processor set, such as a microprocessor with a graphics co-processor.

The dynamic map generator 266 exercises an imagery analysis 300, shown in FIG. 3, on the overhead imagery data in accordance with a first aspect of the invention. The imagery analysis 300 is, in the illustrated embodiment, an object-oriented analysis. Alternative embodiments may employ a pixel-based analysis. However, object-oriented analysis is typically more robust than pixel-based analysis because (1) it provides a capability for relating objects to one another within the context of the image, and (2) permits the same types of analyses that are available in a pixel-based approach. The illustrated embodiment therefore employs the object-oriented approach illustrated in FIG. 3.

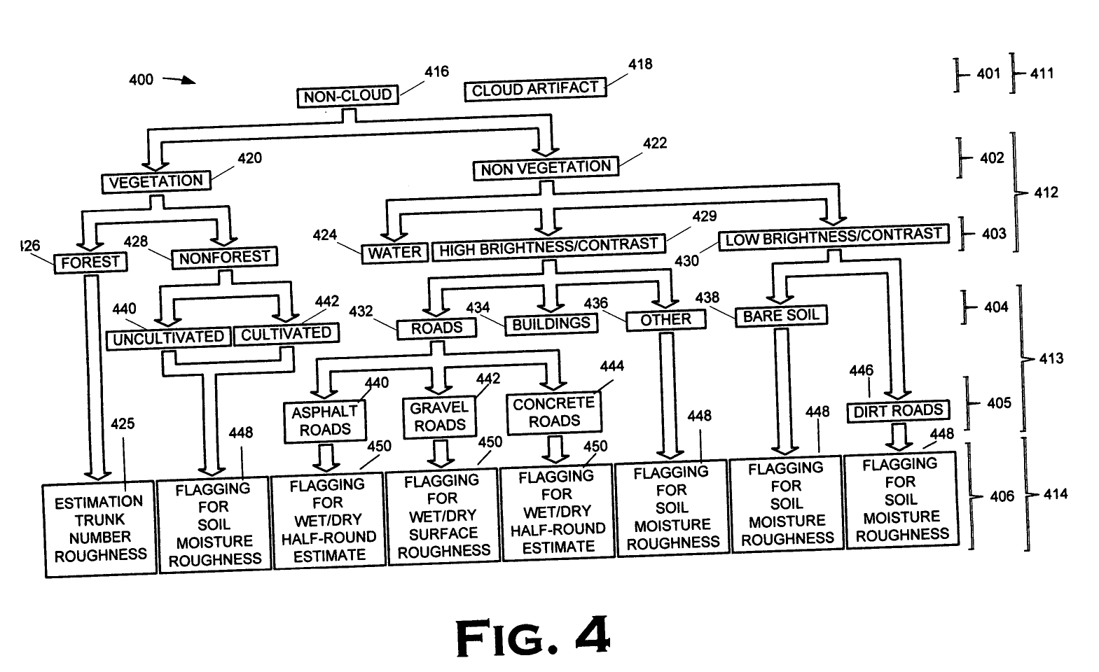

The imagery analysis 300 processes a knowledge rules base in a hierarchical knowledge class tree 400, shown in FIG. 4, implemented in a six-step solution process to generate dynamic mobility maps of a given terrain. As will be discussed further below, the dynamic mobility map is made up of polygons representing various features of interest, or “objects”, represented in the overhead imagery data. The polygons are tagged, or carry with the polygon, mobility parameters relevant to the polygon. The six-step solution process 400 represents a knowledge base 500, shown in FIG. 5, encapsulated in a hierarchal class tree for implementation by the application 265, shown in FIG. 2. The dynamic map generator 266 prosecutes the knowledge base 500 to ascertain mobility attributes derived from the data fusion of metadata from a tactical network 510, also shown in FIG. 5, with the polygons from the imagery analysis in a manner more fully disclosed below.

The route planner 268 is a self-contained route/mission-planning tool capable of performing a mobility and route planning analysis reflecting the dynamic data associated with the battlefield terrain, threat avoidance, stealth ness, timeliness, power consumption, and mission requirements in accordance with a second aspect of the invention. A preferred route for the conditions present in the dynamic mobility map is determined for the unique vehicular parameters, the operator's intent and mission critical data. The selected route, for manned vehicles, is then presented to the driver in visual and audible modes to assist in accomplishing the mission. For unmanned vehicles, e.g., the ground vehicle 100 in FIG. 1, the route is translated into navigational commands to be transmitted or stored onboard the ground vehicle 100.

More particularly, the route planner 268 uses the dynamic mobility maps produced by the dynamic map generator 266 to plan tactically preferred mission routes based on the operator's intent, mission critical data, the common operating picture (“COP”) including threat location and to have that route tailored for each particular vehicle's characteristics. The operator's intent is captured by entering waypoints, time delays and desired defilade state, and in the priority selection of the mission criteria data that includes the need for stealth, timeliness, threat avoidance or power consumption. The route planner 268 also reduces the operator's workload by presenting visual/audible aides to help achieve the desired mission route.

More particularly, the dynamic map generator 266, first shown in FIG. 2, includes, as is shown in FIG. 5, an image classification software package 505 and a knowledge rules base 500. The knowledge rules base 500 embodies the hierarchical knowledge class tree 400, first shown in FIG. 4. The image classification software package 505 includes an image analysis engine 508 that operates on the knowledge rules base 500 to apply the hierarchical knowledge class tree 400 to one or more images in the overhead imagery data. The result of this process, described more fully below, results in a set of data in which various objects have been identified, and in which those identifications can be used for a variety of purposes. One exemplary purpose, manifested in the illustrated embodiment, is route planning.

The dynamic map generator 266 also interfaces with a tactical network 510 (not otherwise shown), from which it receives “metadata” concerning the tactical conditions of the terrain. The tactical network 510 may comprise, for example, a Joint Tactical Information and Distribution System (“JTIDS”) tactical network. The JTIDS is a well known and widely implemented network providing jam-resistant, integrated, digital communication of data and voice for command and control, navigation, relative positioning, and identification. JTIDS is a time division multiple access (“TDMA”) communication system operating at L-band frequencies operating over line-of-sight ranges up to 500 nautical miles with automatic relay extension beyond. Spread-spectrum and frequency hopping techniques make JTIDS resistant to jamming and data encryption makes it secure. As a digital system for both data and voice, JTIDS can handle large amounts of data.

One function of JTIDS is to distribute tactical information in digital form. JTIDS technology also locates and identifies subscribers with respect to other users. A JTIDS terminal (not shown) automatically broadcasts outgoing messages at pre-designated, and repeated, intervals. When a terminal is not transmitting, it receives messages sent by other terminals that transmit, in turn, in a prearranged order.

“Metadata” is data other than imagery applicable to the geographic area. Some metadata can be derived from the overhead imagery data, such as precise location and time information. This metadata is used to located additional metadata, or ancillary data, from the tactical network 510. Metadata examples include local weather reports, laser altimeter, radar data, soil and vegetation data or any other non-visual image data. In the illustrated embodiment, the overhead imagery data also include, in addition to the photogrammetric data discussed above, a digital elevation map (“DEM”), not shown in FIG. 5. The DEM is typically available from the source from which the photogrammetric data is obtained. The image classification software package 505 employs an image analysis engine 508 to operate on the hierarchical knowledge class tree 400, the overhead imagery data, and the metadata to generate a dynamic map of the terrain which is then exported to the dynamic map repository 515. The dynamic map repository 515 may be encoded in the storage 210 of the computing apparatus 200, shown in FIG. 2.

The illustrated embodiment implements the image classification software package 505 with a commercially available, off-the-shelf product called eCognition.™ The eCognition™ package is available from:

Definiens Imaging GmbH
Trappentreustrasse 1
80339 München
Germany
Tel. +49-89-2311800
Fax. +49-89-231180 80
<http://www.definiens-imaging.com>

However, other suitable image classification software packages may be employed in alternative embodiments.

The hierarchical knowledge class tree 400, first shown in FIG. 4, comprises six classification levels 401-406 implemented across four processing levels 411-415. Terrain processing and classification takes places on several of the levels 401-406, 411-415 depending on both image features and the presence of various metadata for a given image. Note, however, that alternative embodiments may employ differing numbers of classification levels and processing levels.

Returning to FIG. 3, pre-processing (at 310, FIG. 3) of the overhead imagery data consists of segmenting the image into recognizable associated objects. Segmentation processing time is a function of image complexity and contrast, the greater the number of objects and contrast the longer the segmentation pre-process procedure takes. This pre-processing, object segmentation can be performed conventional fashion using any suitable technique known to the art.

In general, image processing may be triggered (at 305) manually or by automatic timed scan of designated input directories of the storage 210, e.g., the data structure 225. Once a scan is ingested, image pre-processing (at 310) begins, followed by the generation (at 315) of the terrain/vegetation/structure polygons discernable in the image(s) and metadata. The imagery analysis 300 then pairs (at 320) the terrain polygons with the associated DEM and exports (at 325) the terrain information to the dynamic map repository 515.

More particularly, the image and metadata processing takes place in several discrete steps controlled by a simplified Graphic User Interface (“GUI”), i.e., the operator interface 245. The GUI controls basic data input and output directories as well as several other user and automation options. GUI options include map output directories and map output file formats as well as simplistic time-based scanning parameters for automatic input and processing of fresh imagery. Once configured and initiated (at 305), either manually or automatically, and after pre-processing (at 310), the imagery classification software 505 begins processing (at 315, 320) the overhead data imagery using the six-step solution process 400, shown in FIG. 4.

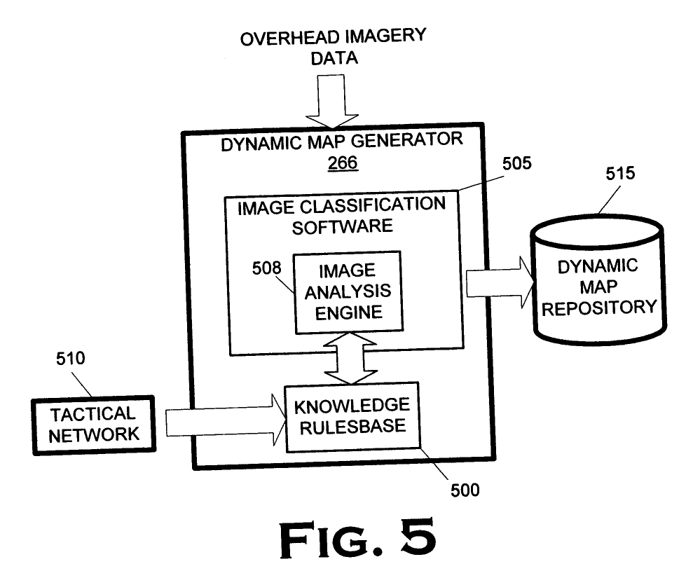

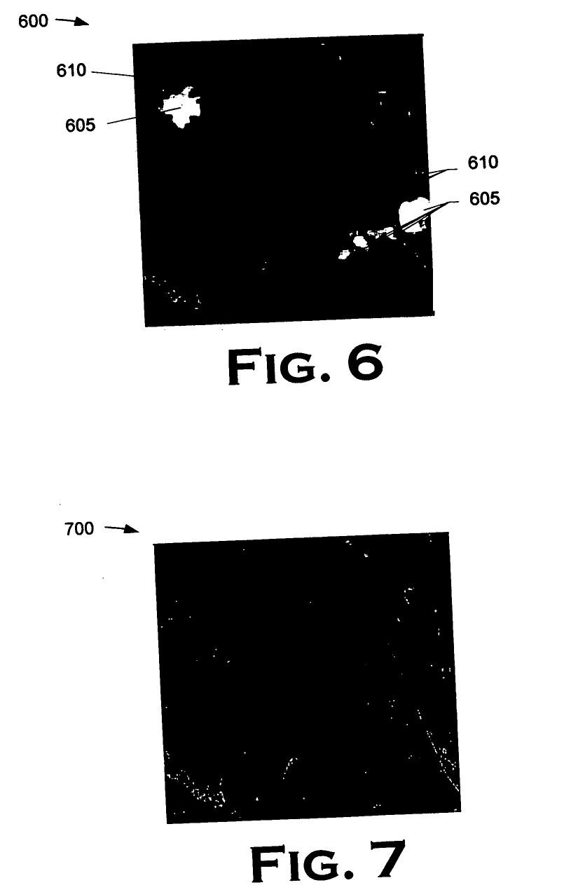

Referring now to FIG. 4, the first level 411 of processing for an image, e.g., the image 600 in FIG. 6, is the removal of data conflicting or interfering with proper terrain classification, e.g., cloud artifacts such as clouds and cloud shadows. Consider the image 600 in FIG. 6, which contains several clouds 605 (in white) and corresponding cloud shadows 610 (in black) that obscure the terrain below. In a first level 401 of object classification by the image classification software 505, the various portions of the image 600 are classed as either non-cloud (at 416) or cloud artifact (at 418). The cloud artifacts 605, 610 may then be removed either through the process of scene subtraction employing a previous image (not shown) from, for example, a previous satellite pass, for the same terrain or by metadata content addition, which will be described more fully below. FIG. 7 depicts an image 700, which is the image 600 of FIG. 6 after this first level 411 of processing.

More technically, the imagery analysis 400 is performed on an object-by-object basis. The image classification software 505 identifies a variety of objects in the image 600. The object identification and subsequent classification will be dependent on the level 411-414 of processing and the level of classification 401-406. Thus, the image classification software 505 identifies each cloud artifact 605, 610 as a polygonal object and the remainder of the image 600 as another polygonal object that are then classed as cloud artifact objects (at 418) and a non-cloud objects (at 416), respectively. In the first processing level 411, the cloud artifacts 605, 610 are then removed and the missing data is substituted therefore.

With the removal of image artifacts, clouds, cloud shadows, and other extraneous data in the first processing level 411, the dynamic map generator 266 proceeds to the second level 412 of processing. This second level 412 comprises a single classification level 402 in which objects are classed as vegetation objects (at 420) or non-vegetation (at 422), i.e., vegetation objects are differentiated from non-vegetation objects. Proper classification of vegetative features from other features can be readily performed given the availability of IR channel and color/contrast information in all available imagery (military and commercial), along with the positional relationship of objects and the normalized vegetation difference index (“NVDI”) data. FIG. 8 illustrates the second level 402 object classification, with vegetation indicated in green and non-vegetation indicated in yellow and/or orange.

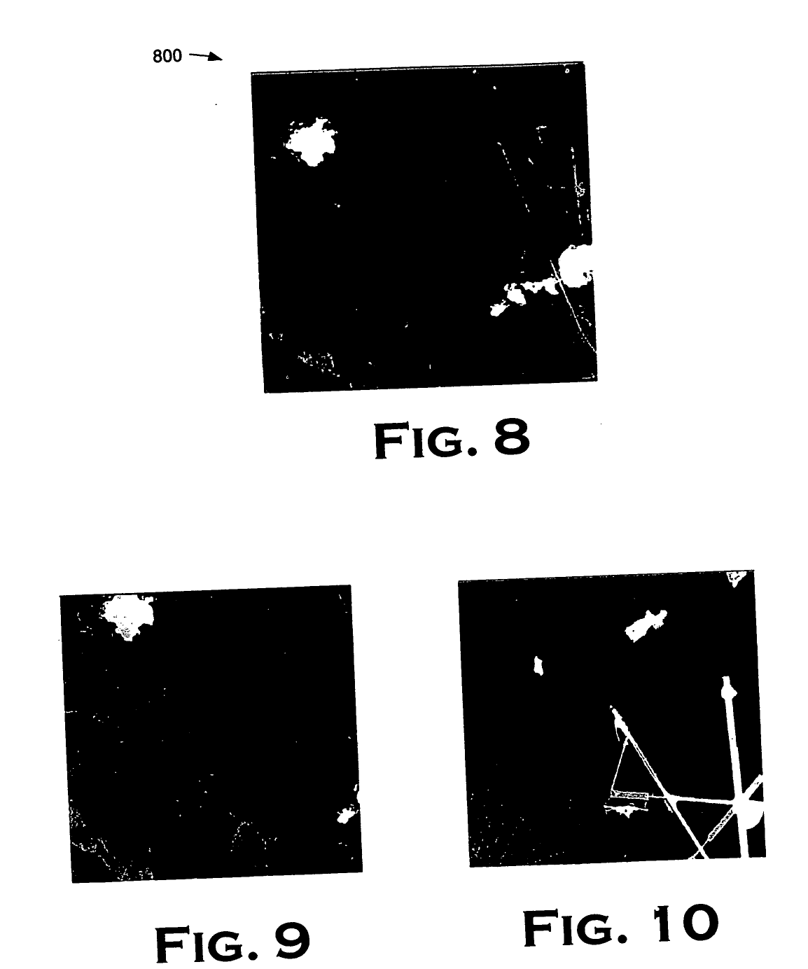

Once the second level 402 object identification is complete, the second level 412 of processing continues to the third level 403 of object classification. At this level, water objects (to include rivers, lakes and streams) are classed (at 424) in the base image. The vegetation objects identified in the second level 402 object classification are further delineated into forest vegetation (at 426) and non-forest vegetation (at 428). In addition to water objects (at 424), the previously identified, non-vegetation objects are identified as high brightness and/or contrast (at 429) and low brightness and/or contrast (at 430). Polygon logic inversion is also employed to simplify and speed the classification process. FIG. 9 illustrates the results of the third level 403 object classification, including classification of fields and crops as independent entities from the forest. Forested and non-forested objects are shown in dark green and light green, respectively, non-vegetation objects are shown in orange, and water objects are shown in dark blue and light blue. Estimates of tree trunk positions can be made at 425, as described more fully below, within the forest object allowing tree spacing to be estimated, thus determining whether a vehicle of a given width may navigate safely within the forest object.

With the completion of level three 403 object classification, further classification of the nature and structure of manmade objects within the image data can commence. The process 400 moves to the third level of processing 413, which begins with the fourth level 404 object classification. Classification of these objects is driven by both geometric shape and the relationship of one object to another. Previously identified (at 429) high brightness/contrast objects are further identified as roads (at 432), buildings (at 434), or “other” objects (at 436). Bare soil is identified (at 438) from among the identified (at 430) low brightness/contrast objects and previously identified (at 428) nonforested, vegetated objects are classed as cultivated (at 440) or uncultivated (at 442).

FIG. 10 illustrates some aspects of this fourth level 404 of object classification. In FIG. 10, roads are shown in blue, buildings in green, large sealed areas in yellow (although not shown in FIG. 4), and “other” objects in red. Intersection of roads with sealed area of similar width can, for example, be used to delineate road and highway intersections from the road or highway proper. Length, width, alignment, and associated buildings of the large sealed area to the right of the figure will result in classification of the object(s) as an airfield (as would the presence of a generalized aircraft shape on any of the associated objects, such as tarmac, runway, etc.). It is also at this level that buildings of all types receive their object classification (at 434). Further, the positioning of buildings in relation to one another can be used to infer the function of a building complex if it is unknown.

While building function classification is not pertinent to the specific derivation of a mobility map, it is important to note that the dynamic map generator 266 is not limited with regards to the employment of multispectral imagery of higher resolution. Just as building function can often be inferred from the presence of secondary objects (fences, antennas, tanks, towers) and their relationship to one another, so can enhanced characterization of surface roughness, road or bridge condition, soil water content (standing water), soil or vegetation type, and other mobility features be used to derive an increasingly accurate mobility map. Thus, in the illustrated embodiment, the dynamic map generator 266 leverages enhanced optical, infrared, or radar sensor resolution with no further action on the part of the user other than adjustment of the rule set defining the process 400 to process the presence of these features in the image.

At the fifth level 405 of object classification (still the third processing level 413), the introduction of the various metadata channels to the task of mobility analysis is initiated. The previous levels 402-404 processed four-meter multispectral data. The fifth level 405 does, as well, but adds, for instance, one-meter panchromatic data. Depending on the types and resolutions of the metadata information, further inference may be made from the optically derived polygons generated to this point. Analysis of laser waveform data, radar waveform return, object-to-object connections, and polygon positional relationships can, for example, differentiate between cultivated fields, naturally occurring meadows, different types of road surfaces, etc. For instance, previously identified (at 432) roads can be differentiated by their surfaces, e.g., asphalt (at 440), gravel (at 442), and concrete (at 444). Previously classed (at 430) low brightness/contrast areas not previously classed as bare soil (at 438) are classed as dirt roads (at 446). Although not shown in FIG. 4, radar return information in particular can be used to differentiate vegetation or crop type, which may or may not provide useful soft cover or hinder mobility depending on the time of year. Metadata can also be applied as in the sixth level 406 of object classification to determine soil moisture (at 448) and/or wet/dry half-round estimation (at 450).

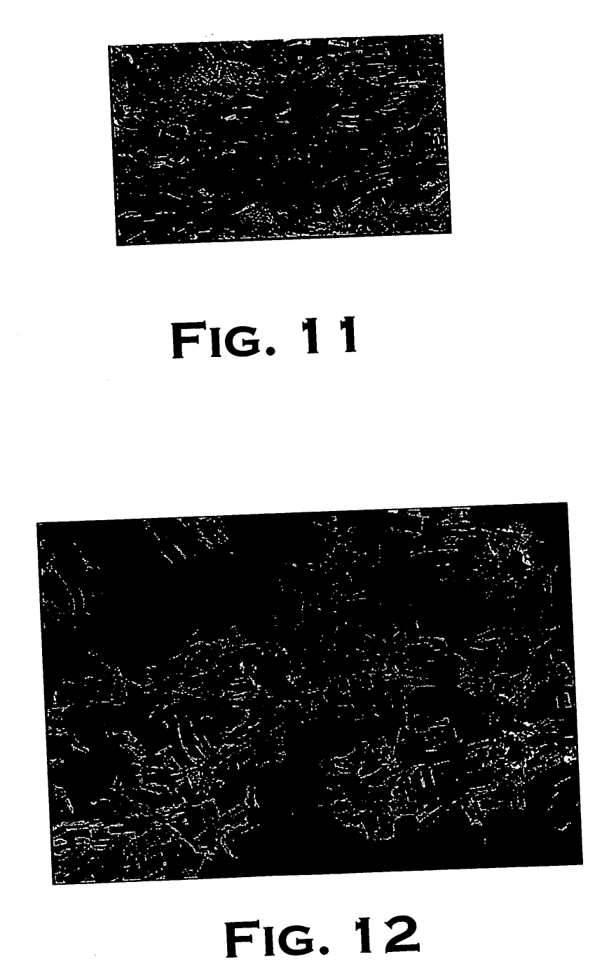

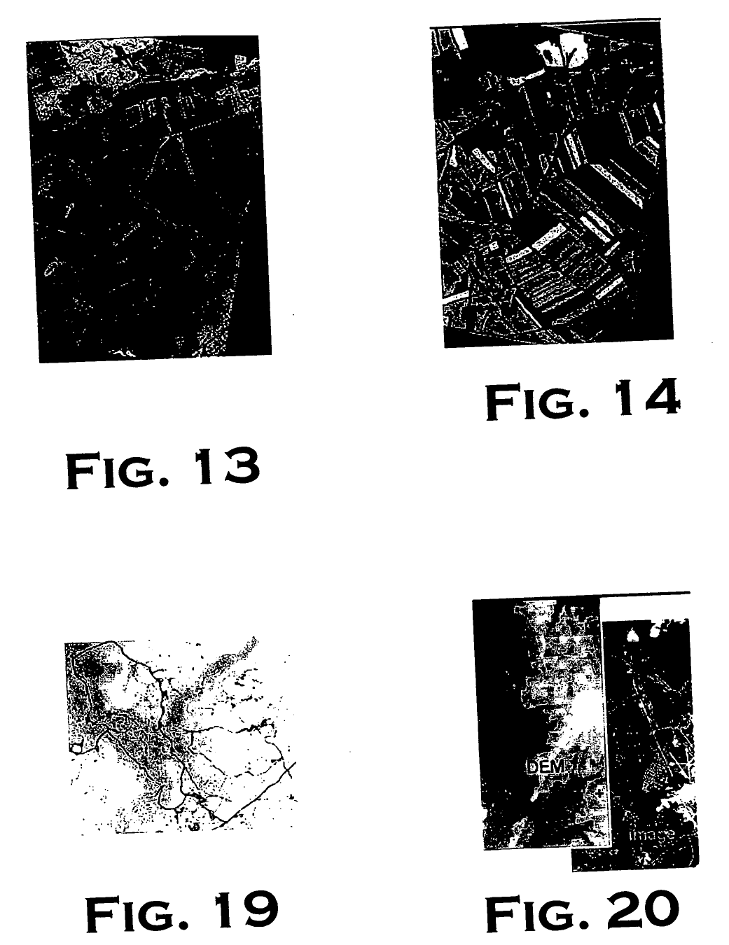

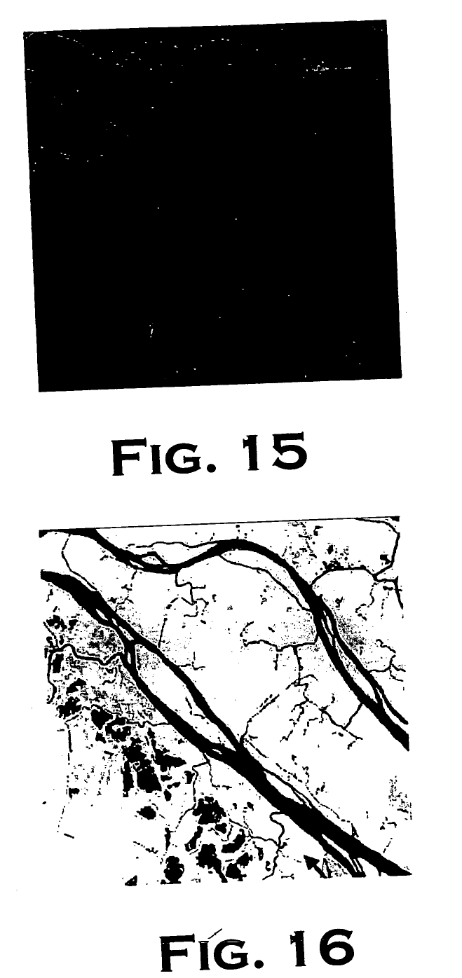

FIG. 11 to FIG. 16 illustrate the results of object classification using laser and synthetic aperture radar returns to determine crop type and differentiation of natural from commercial vegetation planting types. More particularly, FIG. 12 illustrates the application of such metadata to the image of FIG. 11 and FIG. 14 illustrates the application of such metadata to the image of FIG. 13. In FIG. 12, cropland is shown in brown, grassland in gold, forest in green, urban areas in pink, orchards in yellow, and dark objects in purple. In FIG. 14, different kinds of crops are illustrated in different colors. For instance, alfalfa is shown in blue, canola in yellow, corn and potato in pink, forest in fluorescent green, and summer barley and wheat in brown, and winter barley in black. FIG. 15 is a false color image of a rice field, and FIG. 16 shows rice fields seeded in May in yellow and rice fields seeded in August in purple, as classified using the process described herein with metadata.

This type of metadata can also provide significant clues as to the surface roughness of non-vegetated areas, with the sharpness of the returning waveform being a significant indicator of surface roughness for a given location. For instance a sharp radar return may indicate a smooth surface while a less sharp radar return will indicate a rough surface. The minimum size of a resolvable object within the laser and radar metadata is a function of spacecraft altitude, angle, and the specific sensor, but low altitude, high resolution laser information can sense soil objects smaller than 12″. Consequently, rocky fields concealed by grass can in most cases be accurately characterized in the presence of metadata, despite absence of rocks in the visible image. Similarly, water content in soil, or the presence of a soil saturation condition (i.e., mud) can be resolved at this level of inference.

Additional automation features are also potentially available at this fifth level 405 of hierarchy. The rules base 500 for the image classification software 505 may, for example, automatically pull and utilize metadata available anywhere within the limits of the tactical network 510, given that the location and format of the metadata is known to the rules base 500. Meteorological data or static soil databases, for example, can be automatically pulled from the tactical network 510 as required by the imagery analysis software to derive a polygon classification. Such information along with other metadata is useful in determining the degree of mobility interference resulting from a given condition. For example, visual indications of ice on a road surface might be present. This presents a conspicuous mobility impediment and determining the relative degree of the impediment may be important. Inferences to ice thickness can be drawn from geographic location, soil type, and examining, for example, the past 48 hours of temperature and dew point information.

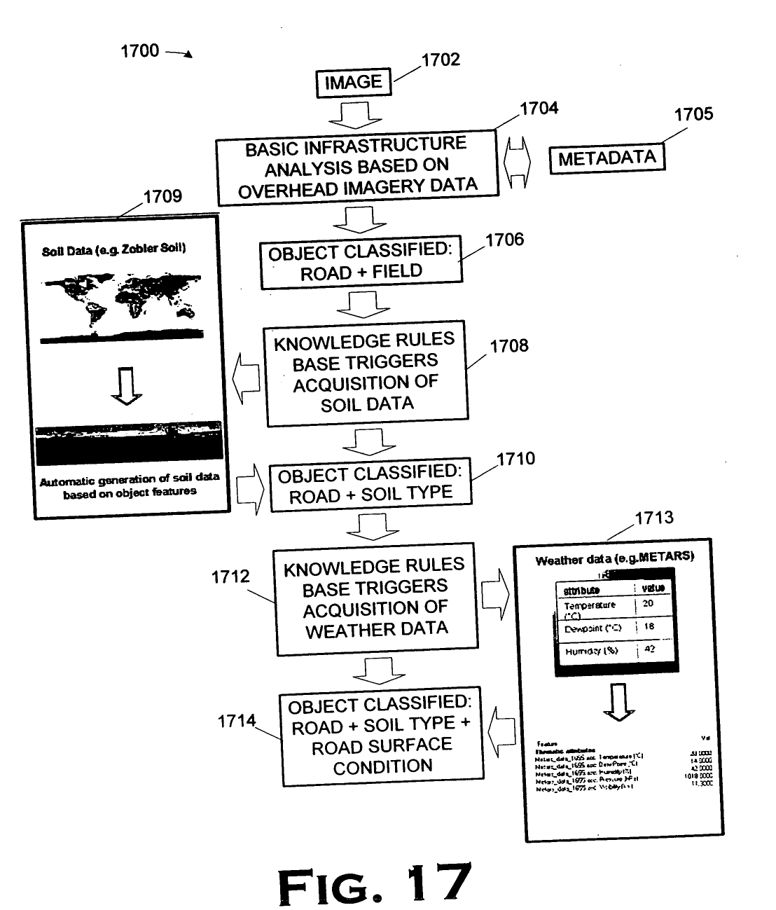

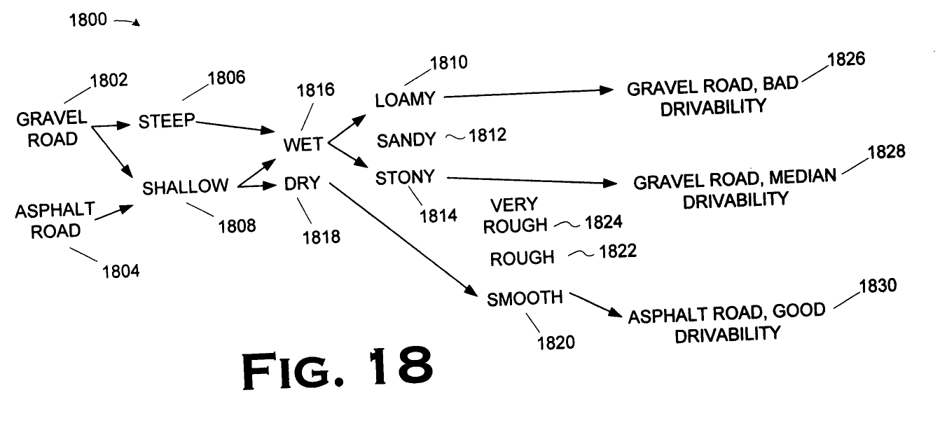

FIG. 17 and FIG. 18 illustrate a pull of network data by the dynamic map generator 266 for use in determining, for example, a set of notional road mobility conditions. FIG. 17 illustrates a process 1700 that takes place in the fifth and sixth levels 405, 406 of object classification. The process 1700 operates on an image 1702 that has already been processed, at 1704 in FIG. 17, through the first four levels 401-404 of object classification. As discussed above, in the illustrated embodiment, this includes the extraction of metadata from the image 1702 that is then, at 1705, loaded into the tactical network 510, shown in FIG. 5. In this particular embodiment, the metadata includes, for example, time, date, and geographic location of the metadata.

In some embodiments, the changes arising from the image processing may be introduced back into the tactical network 510 as metadata. More technically, the image processing stores changes in the imagery from one pass by the overhead platform 108, shown in FIG. 1, to the next in “change files” (not shown). These change files may be introduced back into the tactical network 504, depending on the degree and nature of the changes. For example, large scale changes in vegetation coverage may be of tactical interest whereas small-scale changes may not. Alternatively, some changes may be of high priority. For example, changes to local infrastructure like bridges and roads may be of significant interest even if small-scale. In these embodiments, whenever detected changes are of a nature or degree that they are of sufficient interest, they are introduced back into the tactical network 510 to update the metadata therein. Change data of particular importance to the tactical situation can be introduced on a high priority basis.

Returning to FIG. 17, the object is classed (at 1706) as a road in a field. The knowledge rules base 500, shown in FIG. 5, then triggers (at 1708) the acquisition of metadata from the tactical network 510, also shown in FIG. 5. The soil data 1709 resides on the tactical network 510 and is automatically generated and returned to the process 1700, whereupon it is applied to class (at 1710) the object as a road with a particular soil type. The knowledge rules base 500 then triggers (at 1712) another acquisition of metadata, such as weather data 1713. The weather data 1713 also resides on the tactical network 510, which automatically generates the weather data 1713 and returns it to the process 1700. The process 1700 then classes (at 1714) the object by road, soil type, and road surface condition.

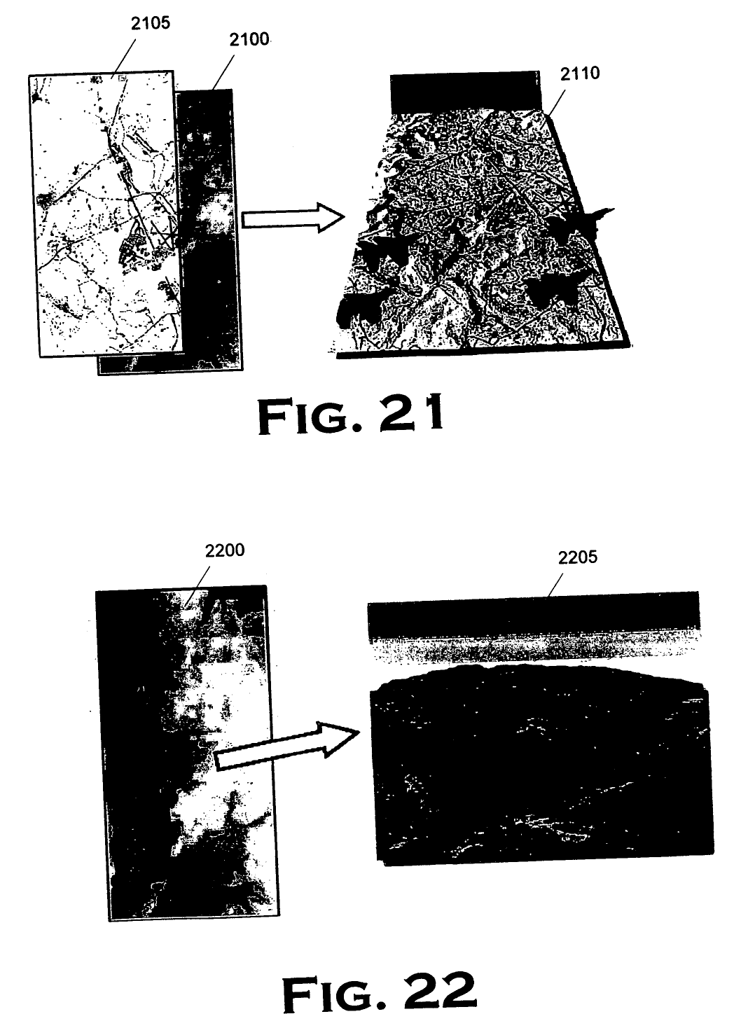

FIG. 18 illustrates an exemplary decision tree 1800 to illustrate the determination of a road surface's drivability in an image, such as the image 1900 in FIG. 19. In FIG. 19, gravel roads are shown in yellow and asphalt roads are shown in a dark gray or black. The road may be, for example at gravel road (at 1802) or an asphalt road (at 1804). Metadata can then be applied to determine whether the grade is steep (at 1806) or shallow (at 1808). Note that the grade is determined from the DEM, discussed above, combined with the base image, as is conceptually illustrated in FIG. 20. The metadata can also be used to determine whether the gravel road has a loamy (at 1810), sandy (at 1812), or stony (at 1814) surface, and whether that surface is wet (at 1816) or dry (at 1818). Roughness estimations, as discussed above, can be used to determine whether the road surface is, for example, smooth (at 1820), rough (at 1822), or very rough (at 1824). Thus, the metadata can yield drivability decisions such as whether the gravel road has bad (at 1826) or median (at 1828) drivability or the asphalt road has good drivability (at 1830).

Returning now to FIG. 4, with the completion of fifth level 405 object classification, and the incorporation of metadata in the sixth level 406 object classification, the dynamic map generator 266 is ready to generate the resultant dynamic mobility map. To some degree, this step will be implementation specific depending on the use to which the map will be put. Thus, the map may be generated and output in any of one or more of several formats. The format may be selected by the operator 102, shown in FIG. 1. The result is exported to the dynamic map repository 515. In some embodiments, this generation may be performed automatically employing a default format.

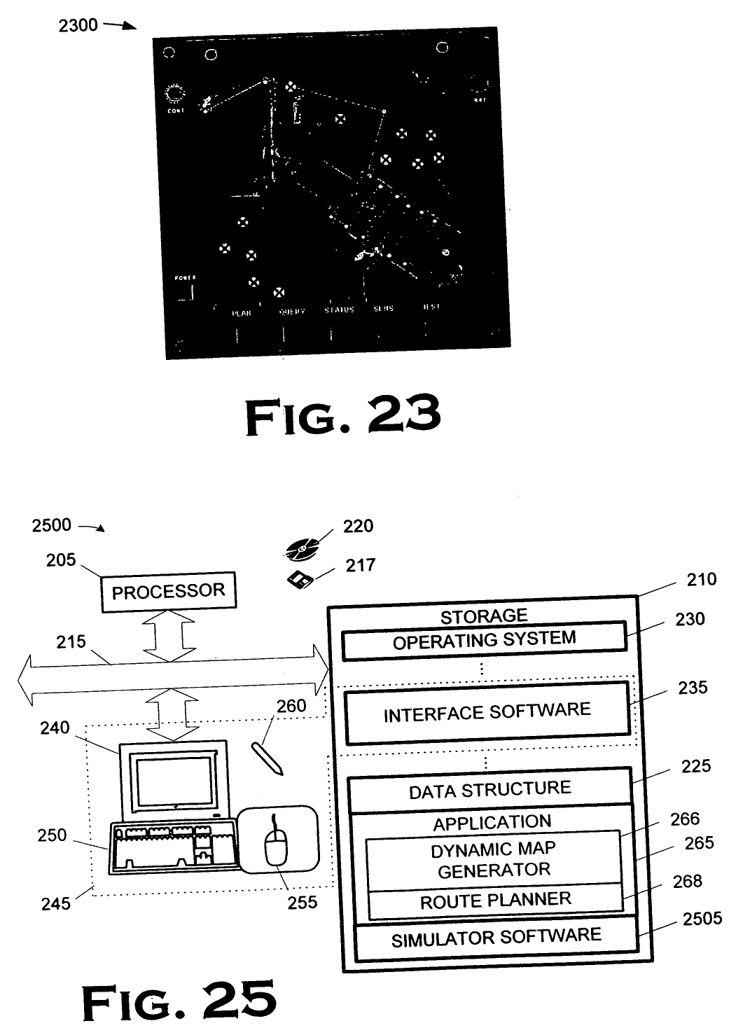

In the illustrated embodiment, the resultant dynamic mobility map is displayed to the operator 102, shown in FIG. 1. The dynamic map generator 266 merges the digital elevation map (“DEM”), first described above, with the polygons (i.e., the classified objects of the base image) derived from the classification process. FIG. 21 conceptually illustrates an exemplary merger of a DEM 2100 with a classified image 2105 and its export into a dynamic mobility map 2110 in the Compact Terrain Database (“CTDB”) format (version 7). In the illustrated embodiment, the CTDB format is the default. The CTDB formatted dynamic mobility map 2110 is written along with matching stand-alone text/shape file(s) to permit use of the full range of available data, some of which may not be incorporated into the CTDB format, version 7. In the case of later CTDB variants (i.e., version 8) a one-for-one mapping of soil types and mobility information is possible, as this CTDB variant has been expanded to allow for storage of the appropriate information. Still other formats, such as the OpenFlight and GIS industry standard formats, may be employed in alternative embodiments. FIG. 22 conceptually illustrates the export of a merged classified/DEM image 2200 into a dynamic mobility map 2205 in the OpenFlight format.

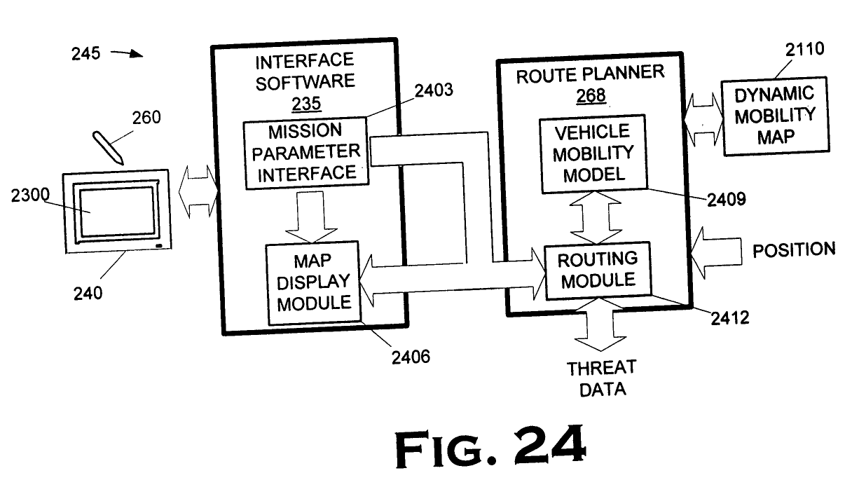

Returning to FIG. 2, as mentioned above, the dynamic mobility map generator 266 generates a dynamic mobility map (e.g., the dynamic mobility map 2115, in FIG. 21) for use in planning a route for the ground vehicle 100, shown in FIG. 1. The route planner 268 accesses the dynamic mobility map and displays it to the operator 102 through the operator interface 245. FIG. 23 illustrates one exemplary two-dimensional (“2D”) display 2300 of the three-dimensional dynamic mobility map. The operator interface 245 also receives input from the operator 102 to help in planning a route in accordance with parameters desired by the operator 102.

More particularly, FIG. 24 illustrates the route planner 268 and the user interface 245 in greater detail relative to this aspect of the present invention. The interface software 235 comprises at least a mission parameter interface 2403 and a map display module 2406. The route planner 268 comprises at least a vehicle mobility model 2409 and a routing module 2412. In general, the operator interface 245 allows the operator to test and interact with the route planner 268 and review the results/effects of this interaction and the effects of threats, obstacles, and terrain features on route generation.

Referring first to the operator interface 245, the mission parameter interface 2403 receives the input of the operator 102 regarding mission criteria, cost, and other factors, and a request a route to be generated. Operator input mission criteria may include various mission parameters, such as mission destination, fuel on board, fuel consumption, grade capability, side slope capability, minimum turn radius, approach angle, departure angle, maximum speed, etc. Note that the number and choice of mission criteria will be implementation specific. Operator input mission cost factors, are used, in the illustrated embodiment, as weights in choosing a route. Mission cost factors may include, for example, various factors such as time to destination (function of mobility), proximity to threat, exposure time (function of proximity to threat and other factors), detectability, etc. Other factors that may affect the route selection process may include atmospheric conditions such as visibility and wind direction (affects acoustic detection), presence of obscurants (affects visibility), time of day, etc.

The map display module 2406 facilitates operator interaction with a 2D Plan View Display (“PVD”) for viewing of the UGV, threat(s), the calculated route, and terrain features. The map display module 2406 generates a 2D display (e.g., the display 2300) from the 3D dynamic mobility map (e.g., the dynamic mobility map 2110, in FIG. 21), and overlays it with route planning and other information. The overlay information may include, for example, threats, obstacles, and the route itself. This map display module 2406 may be implemented using any suitable technique known to the art. For instance, suitable off-the-shelf software development tools such as VIRTUAL APPLICATIONS PROTOTYPING SYSTEM™ (“VAPS”), available from:

eNGENUITY Technologies Inc.
4700 de la Savane, Suite 300
Montreal, Quebec
CANADA H4P 1T7
Tel: (514) 341-3874
Fax: (514) 341-8018
E-Mail: info@engenuitytech.com

or MOVING MAP ACTIVEX™, available from:

Global Majic Software, Inc.
6767 Old Madison Pike
Building 2, Suite 210
Huntsville, Alabama 35806
Tel: (256) 922.0222
Fax: (256) 922.0708
E-Mail: info@globalmajic.com

However, other suitable tools may be employed in alternative embodiments.

Additionally, in the illustrated embodiment, an optional vehicle control interface (not shown) will allow the operator 102 to hide or display a projected route (i.e., a de-clutter function), accept or reject the projected route, and command the ground vehicle 100 to “go” or to “stop.” An ability to select manual or automatic route recalculation based on dynamic changes in the mobility information or the identified threats may also be added.

Turning now to the route planner 268, the vehicle mobility model 2409 models the projected performance of the ground vehicle 100 in the terrain represented by the dynamic mobility map 2110. In the illustrated embodiment, the ground vehicle 100 is a military vehicle, and the vehicle mobility model 2409 will be implemented using the North American Treaty Organization (“NATO”) Reference Mobility Model 2 (“NRMM2”) available from U.S. Army Training and Doctrine Command (“TRADOC”) Analysis Center (TRAC), in Monterey, Calif., U.S.A. The invention is not so limited, however, and any suitable model may be employed. Those in the art having the benefit of this disclosure will further appreciate that the implementation of the vehicle mobility model 2409 will depend to some degree on the implementation of the vehicle to be modeled, i.e., the ground vehicle 100. Input to the vehicle mobility model 2409 includes the dynamic mobility map 2110 as well as the remolded cone index (“RCI”), adjusted speed, deflection, and resistance for each particular soil type. The vehicle mobility model 2409 uses these inputs along with vehicle physical attributes (i.e., weight, track or tire width, horsepower, physical dimensions, etc.) to determine the speed at which the vehicle can traverse the given terrain patch.

The routing module 2412 will be, in the illustrated embodiment, implemented using the PATHFINDER route planning tool, also available from the U.S. Army TRADOC TRAC. The Pathfinder software component will use the mobility information from the vehicle mobility model 2409, threat information, and position information for the ground vehicle 100 to calculate a route that satisfies the current threat and environmental situation as well as the operator input mission criteria and cost factors. The routing module 2412 also received threat data over the tactical network 510, shown in FIG. 5. The routing module 2412 will then iteratively compute a route that best fits the input criteria. If no route can be found that meets the input criteria, the route closest to satisfying these requirements will be returned. The routing module 2412 will then pass the calculated route to the operator interface 245 for display and, if applicable, for confirmation purposes. At this point the operator 102 will have the option of either accepting the route or modifying the input criteria and requesting that another route be calculated.

Returning now to FIG. 1, in operation, the overhead imagery data is acquired by the overhead platform 108 (e.g., the satellite 112 or aircraft 114) and transmitted to the data processing facility 109 over a wireless communications link 110. The processing facility 109 pre-processes the overhead imagery data, e.g., as described above for the photogrammetric data. The overhead imagery data is then downloaded to the ground vehicle 100 and encoded onto the storage 210, e.g., in the data structure 225. In the illustrated embodiment, this done by encoding the overhead imagery data onto optical disks, e.g., the optical disk 220, and inserting the optical disk in a rack mounted drive (not shown) in the chassis of the ground vehicle 100.

The ground vehicle 100 is then deployed to the field in any suitable manner. Typically, the operator 102 is deployed with the vehicle, but the invention is not so limited. The operator 102 may remain at the data processing facility 109, for instance, or may be deployed separately from the ground vehicle 100 at some distance therefrom. The operator 102 may then enter mission data in the route points for things like observing a point of interest or as a bivouac point through the mission parameter interface 2403 of the operator interface 245. The time delay and the desired defilade status complete the data. The operator selects the route criteria. The operator 102 has a sliding scale to choose the route dependent on time criticality, stealth criticality, threat avoidance, or power consumption. The input from the operator 102 is then transmitted to the ground vehicle 100 over the wireless communications link 106.

As those in the art having the benefit of this disclosure will appreciate, the deployment may take several hours to several days. Conditions in the deployment area may change quite rapidly and may be quite different than they did when the deployment began. Thus, in this sense, the overhead imagery encoded in the storage 210 prior to deployment may be “stale.” Furthermore, the overhead platform 108, or other overhead platforms (not shown) may continue to acquire overhead imagery data from the area that is transmitted to the data processing facility 109. In conventional practice, more recent, or “fresher”, data may be available, but the ground vehicle 100 has no access to it and so operates on stale data.

The present invention, however, communicate the fresh data to the ground vehicle 100 from the data processing facility 109 over the wireless communication link 120. More precisely, in the illustrated embodiment, the fresh data is compared at the data processing facility 109 to the data encoded in the storage 210. The comparison generates a set of “change data” that indicates only the differences between the fresh and stale sets of overhead imagery data. The change data is then transmitted to the ground vehicle 100 over the wireless communication link 120. Note that, in some embodiments, the wireless communication link 120 may include a relay from a communications satellite (not shown). The change data may be generated and transmitted, for instance, whenever a fresh set of overhead imagery data is acquired or when prompted for an update by the ground vehicle 100.

The transmission of only change data is advantageous because, as previously mentioned, the overhead imagery data is relatively voluminous. To transmit the entire fresh data set would require significantly greater time, bandwidth, power, and cost. However, the invention is not limited to “updating” the overhead imagery data in the manner described above. The present invention contemplates that some alternative embodiments may, indeed, transmit the entire fresh set of overhead imagery data to the ground vehicle 100. Note that, in these embodiments, there is no need to download overhead imagery data to the ground vehicle 100 prior to deployment, since the ground vehicle 100 will receive an entire set in the field after deployment.

Returning to FIG. 1, once the ground vehicle 100 receives the change data, the computing device 205, shown in FIG. 2, overlays the change data on the stored overhead imagery data. The computing device 205 then invokes the application 266. The invocation of the application 266 triggers the processing (at 305, FIG. 3) of the combined overhead imagery data set by the dynamic map generator 266. The overhead imagery data is then processed (at 315) by the dynamic map generator 266 to classify the objects (i.e., generate polygons) using the classification process 400 illustrated in FIG. 4 and described above. The dynamic map generator 266 then pairs (at 320) the classed objects (i.e., the generated polygons) with the DEM to generate the dynamic mobility map (e.g., the map 2110, FIG. 21).

The routing module 2412, shown in FIG. 24, of the route planner 268 then plans a route from the dynamic mobility map 2110, the mission parameters received through the operator interface 245, the threat data, and the position of the ground vehicle 100 using the vehicle mobility model 2409. The routing module 2412 then computes a route as described above and presents it to the operator 102 through the map display module 2406 of the operator interface 245. The operator 102 can then accept or reject the presented route. If accepted, the route is then sent to the driver for visual and audible display or as a navigational command set for an unmanned ground vehicle. If rejected, the route planner 268 may develop an alternative route, sometimes with changes to the parameters from the operator 102.

As was mentioned above, some embodiments may employ multiple vehicles 100 planning routes from the same overhead imagery data. In these embodiments, representation of the generated terrain (i.e., the dynamic mobility map) for onboard use by the vehicles 100 may remain problematical as internal terrain representation and sensor capabilities currently vary from ground vehicle 100 to ground vehicle 100. A uniform standard for internal terrain representation would ultimately be of great value in streamlining the mobility map generation process in a tactical environment. If multiple internal formats remain the norm, then the changes noted in the mobility map with each satellite pass or image arrival would have to be transmitted in multiple formats for use by each UGV type or class. While the polygon change files themselves are small when compared to the size of baseline mobility map, transmission of identical information in several file formats represents a complicated and vulnerable process.

Thus, the illustrated embodiment provides a low-cost, stand alone, automated ability to generate rapidly updateable dynamic mobility maps from overhead imagery data. This capability is further enhanced by the integration of the dynamic mobility map output by the dynamic map generator with the route planner including an embedded vehicle specific parameter file, a vehicle mobility model, a routing module, and situational awareness data provided over the tactical network, the operator's intent, and mission critical data. The ability to analyze terrain in near real time offers great advantages, particularly on a dynamic battlefield. Lives and time can be saved by just knowing where rubble from bombed buildings have blocked a street making it impassable, a trap, or a perfect ambush situation. Knowing in near real time where damage to a bridge makes it no longer safe to cross is an advantage. Critical time can be saved; needless searching for an alternative route can be avoided. The automated route planner allows the operator to select and input his intent and then presents that information to the driver and tracks progress along the route and will greatly alleviate the overloaded operator. The time no longer spent coaching the driver, can now be applied to fighting the weapon system or to vital reporting/fact gathering.

With respect to UGV applications, the sensor requirements, sensor load and computational loads for unmanned vehicles may be greatly reduced by having safe maneuver corridors identified from UAV/Satellite imagery. Knowing that it is operating in a safe maneuver corridor largely negates the need to regard mobility objects in the near field of view simplifying the navigational task. Relieving onboard processing time should greatly enhance the speed at which a UGV may transverse the given terrain. Generally speaking, greater speed, or shorter mission time, typically translates to greater survivability.

As mentioned above, the illustrated embodiment is but one application to which the present invention may be put. The illustrated embodiment employs the present invention to navigate an unmanned ground vehicle 100 through a combat environment. However, the invention is not so limited. For instance, the ground vehicle 100 may be manned in some alternative embodiments. The ground vehicle 100 may be deployed in non-combat environments in some other alternative embodiments. In still other embodiments, both the variations may be found.

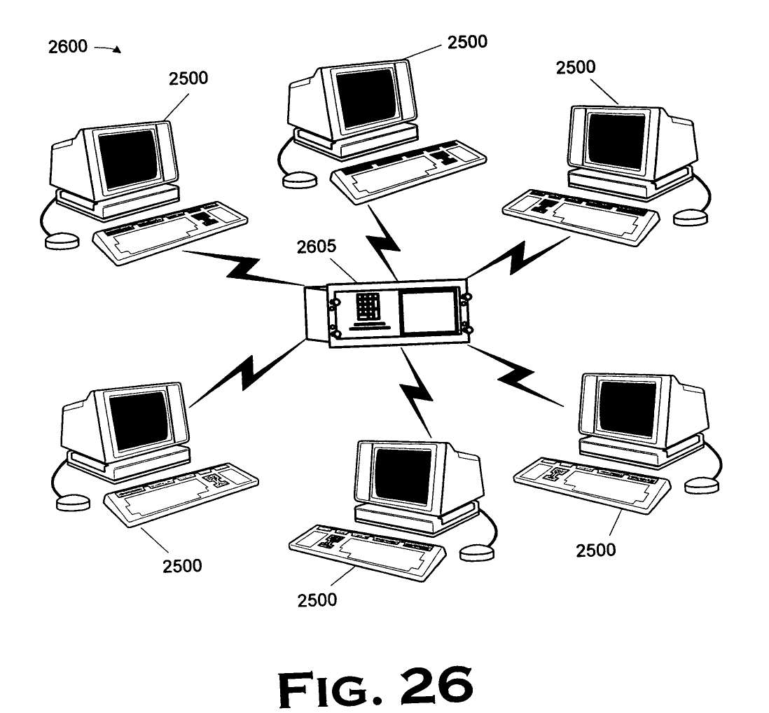

The invention may not even be employed to navigate a vehicle (e.g., the ground vehicle 100, FIG. 1) in some alternative embodiments. The invention may be employed, for instance, to simulate the operation of a vehicle through a given environment. Consider the computing apparatus 2500, shown in FIG. 25. The computing apparatus 2500 is but one implementation of the computing apparatus 200, and comprises a workstation programmed as a simulator. The computing apparatus 2500, accordingly, is programmed with simulator software 2505 that interacts with the application 265. The invention may also be employed in a distributed, integrated simulation (“DIS”) environment 2600, shown in FIG. 26. The DIS 2600 includes a central computing apparatus 2605 (e.g., a server), and multiple simulators 2500 that communicate with the central computing apparatus 2605 over the communications links 2615. Commercially available simulators and DIS environments suitable for modification in accordance with the invention are well known and readily available. One such unit is marketed to the United States Armed Forces by Lockheed Martin Corporation under the mark TOPSCENE.™ The modifications needed to such a unit will be readily apparent to those skilled in the art having the benefit of this disclosure.

Some portions of the detailed descriptions herein are presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for generating a dynamic mobility map, comprising:
classifying a plurality of objects represented in a data set comprised of overhead imagery data; and
classifying the objects through application of dynamic data pertaining to those objects.

2. The method of claim 1, wherein classifying the objects through application of dynamic data includes:
updating the overhead imagery data with change data prior to beginning the classification; and
classifying the objects through the updated overhead imagery data.

3. The method of claim 1, wherein classifying the objects represented in the overhead imagery data includes applying an image analysis engine to a knowledge rules base to operate on the overhead imagery data.

4. The method of claim 3 classifying the objects through application of the dynamic data includes applying the image analysis engine to the knowledge rules base to operate on the dynamic data.

5. The method of claim 3, wherein the knowledge rules base implements a hierarchical knowledge class tree.

6. The method of claim 1, wherein classifying the objects through application of dynamic data pertaining to those objects includes applying an image analysis engine to a knowledge rules base to operate on the dynamic data.

7. The method of claim 6, wherein the knowledge rules base implements a hierarchical knowledge class tree.

8. The method of claim 1, further comprising at least one of:
exporting the dynamic mobility map in a terrain database format;
reading the overhead imagery data from a storage;
merging the classified objects with a digital elevation map.

9. The method of claim 8, wherein reading the overhead imagery data from a storage includes at least one of:
buffering the overhead imagery data in the storage on receipt of a broadcast of the overhead imagery data; and
downloading the overhead imagery data to the storage.

10. The method of claim 9, wherein downloading the overhead imagery data to the storage includes at least one of:
downloading the overhead imagery data to the storage prior to deployment; and
downloading the overhead imagery data to the storage during deployment.

11. The method of claim 1, wherein further classifying the objects through application of dynamic data includes acquiring the dynamic data.

12. The method of claim 11, wherein acquiring the dynamic data includes acquiring the dynamic data over a tactical network.

13. The method of claim 12, wherein acquiring the dynamic data over the tactical network includes automatically pulling the dynamic data.

14. The method of claim 11, wherein acquiring the dynamic data includes automatically pulling the dynamic data.

15. The method of claim 1, further comprising one of:
navigating a vehicle;
simulating the navigation of a vehicle; and
rehearsing a mission scenario.

16. A program storage medium encoded with instructions that, when executed by a computing device, perform a method for generating a dynamic mobility map, the method comprising:
classifying a plurality of objects represented in a data set comprised of overhead imagery data; and
classifying the objects through application of dynamic data pertaining to those objects.

17. The program storage medium of claim 16, wherein classifying the objects through application of dynamic data in the encoded method includes:
updating the overhead imagery data with change data prior to beginning the classification; and
classifying the objects through the updated overhead imagery data.

18. The program storage medium of claim 16, wherein classifying the objects represented in the overhead imagery data in the encoded method includes applying an image analysis engine to a knowledge rules base to operate on the overhead imagery data.

19. The program storage medium of claim 16, wherein classifying the objects through application of dynamic data pertaining to those objects in the encoded method includes applying an image analysis engine to a knowledge rules base to operate on the dynamic data.

20. The program storage medium of claim 16, wherein the encoded method further comprises at least one of:
exporting the dynamic mobility map in a terrain database format;
reading the overhead imagery data from a storage;
merging the classified objects with a digital elevation map.

21. The program storage medium of claim 16, wherein further classifying the objects through application of dynamic data in the encoded method includes acquiring the dynamic data.

22. A computing apparatus, comprising:
a computing device;
a bus system;
a storage with which the computing device communicates over the bus system; and
an application residing in the storage and capable of performing a method for generating a dynamic mobility map when invoked by the computing device, the method comprising:
classifying a plurality of objects represented in a data set comprised of overhead imagery data; and
classifying the objects through application of dynamic data pertaining to those objects.

23. The computing apparatus of claim 22, wherein classifying the objects through application of dynamic data in the programmed method includes:
updating the overhead imagery data with change data prior to beginning the classification; and
classifying the objects through the updated overhead imagery data.

24. The computing apparatus of claim 22, wherein classifying the objects represented in the overhead imagery data in the programmed method includes applying an image analysis engine to a knowledge rules base to operate on the overhead imagery data.

25. The computing apparatus of claim 22, wherein classifying the objects through application of dynamic data pertaining to those objects in the programmed method includes applying an image analysis engine to a knowledge rules base to operate on the dynamic data.

26. The computing apparatus of claim 22, wherein the programmed method further comprises at least one of:
exporting the dynamic mobility map in a terrain database format;
reading the overhead imagery data from a storage;
merging the classified objects with a digital elevation map.

27. The computing apparatus of claim 22, wherein further classifying the objects through application of dynamic data in the programmed method includes acquiring the dynamic data.

28. A method for planning a route for a vehicle, comprising:
acquiring a set of mission parameters;
planning a route from the classification of objects in a dynamic mobility map derived from dynamic data in light of the acquired mission parameters and a position; and
presenting the route to an operator.

29. The method of claim 28, wherein acquiring the mission parameters includes at least one of receiving the mission parameters from the operator, receiving the mission parameters broadcast from another location, and receiving mission parameters downloaded prior to deployment.

30. The method of claim 29, wherein receiving the mission parameters from the operator include receiving the mission parameters through a computer implemented operator interface.

31. The method of claim 30, wherein the computer implemented operator interface includes a display and a software implemented mission parameter interface.

32. The method of claim 28, wherein planning the route includes planning a route in light of threat information.

33. The method of claim 32, further comprising acquiring the threat data.

34. The method of claim 33, wherein acquiring the threat data includes acquiring the threat data through at least one of receiving the threat data from the operator, receiving the threat data over a tactical network, receiving the threat data broadcast from another location, and downloading the threat data prior to deployment.

35. The method of claim 28, wherein presenting the route to the operator includes presenting the route through a computer implemented operator interface.

36. The method of claim 35, wherein the computer implemented operator interface includes a display and a software implemented map display module.

37. The method of claim 28, wherein presenting the route to the operator includes presenting a two-dimensional display to the operator.

38. The method of claim 28, further comprising one of:
receiving an indication of whether the route has been accepted;
transmitting the route for implementation upon receiving an indication that the route has been accepted; and
planning an alternative route upon receiving an indication that the route has not been accepted.

39. The method of claim 28, wherein classifying the includes:
updating the overhead imagery data with change data prior to beginning the classification; and
classifying the objects through the updated overhead imagery data.

40. The method of claim 28, wherein classifying the includes applying an image analysis engine to a knowledge rules base to operate on the overhead imagery data.

41. The method of claim 28, wherein classifying the objects includes applying an image analysis engine to a knowledge rules base to operate on the dynamic data.

42. The method of claim 28, further comprising at least one of:
exporting the dynamic mobility map in a terrain database format;
reading the overhead imagery data from a storage;
merging the classified objects with a digital elevation map;
acquiring the dynamic data;
navigating the vehicle;
simulating the navigation of the vehicle; and
rehearsing a mission scenario.

43. A program storage medium encoded with instructions that, when executed by a computing device, perform a method for planning a route for a vehicle, comprising:
acquiring a set of mission parameters;
planning a route from the classification of objects in a dynamic mobility map derived from dynamic data in light of the acquired mission parameters and a position; and
presenting the route to an operator.

44. The program storage medium of claim 43, wherein acquiring the mission parameters in the encoded method includes at least one of receiving the mission parameters from the operator, receiving the mission parameters broadcast from another location, and receiving mission parameters downloaded prior to deployment.

45. The program storage medium of claim 43, wherein planning the route in the encoded method includes planning a route in light of threat information.

46. The program storage medium of claim 43, wherein presenting the route to the operator in the encoded method includes at least one of:
presenting the route through a computer implemented operator interface; and
presenting a two-dimensional display to the operator.

47. The program storage medium of claim 43, wherein the encoded method further comprises one of:
receiving an indication of whether the route has been accepted;
transmitting the route for implementation upon receiving an indication that the route has been accepted; and
planning an alternative route upon receiving an indication that the route has not been accepted.

48. The program storage medium of claim 43, wherein classifying the in the encoded method includes:
updating the overhead imagery data with change data prior to beginning the classification; and
classifying the objects through the updated overhead imagery data.

49. The program storage medium of claim 43, wherein classifying the in the encoded method includes applying an image analysis engine to a knowledge rules base to operate on the overhead imagery data.

50. The program storage medium of claim 43, wherein classifying the objects in the encoded method includes applying an image analysis engine to a knowledge rules base to operate on the dynamic data.

51. The program storage medium of claim 43, wherein the encoded method further comprises at least one of:
exporting the dynamic mobility map in a terrain database format;
reading the overhead imagery data from a storage;
merging the classified objects with a digital elevation map;
acquiring the dynamic data;
navigating a vehicle;
simulating the navigation of a vehicle; and
rehearsing a mission scenario.

52. A computing apparatus, comprising:
a computing device;
a bus system;
a storage with which the computing device communicates over the bus system; and
an application residing in the storage and capable of performing a method for planning a route for a vehicle when invoked by the computing device, the method comprising:
acquiring a set of mission parameters;
planning a route from the classification of objects in a dynamic mobility map derived from dynamic data in light of the acquired mission parameters and a position; and
presenting the route to an operator.

53. The computing apparatus of claim 52, wherein acquiring the mission parameters in the programmed method includes at least one of receiving the mission parameters from the operator, receiving the mission parameters broadcast from another location, and receiving mission parameters downloaded prior to deployment.

54. The computing apparatus of claim 52, wherein planning the route in the programmed method includes planning a route in light of threat information.

55. The computing apparatus of claim 52, wherein presenting the route to the operator in the programmed method includes at least one of:
presenting the route through a computer implemented operator interface; and
presenting a two-dimensional display to the operator.

56. The computing apparatus of claim 52, wherein the programmed method further comprises one of:
receiving an indication of whether the route has been accepted;
transmitting the route for implementation upon receiving an indication that the route has been accepted; and
planning an alternative route upon receiving an indication that the route has not been accepted.

57. The computing apparatus of claim 52, wherein classifying the in the programmed method includes:
updating the overhead imagery data with change data prior to beginning the classification; and
classifying the objects through the updated overhead imagery data.

58. The computing apparatus of claim 52, wherein classifying the in the programmed method includes applying an image analysis engine to a knowledge rules base to operate on the overhead imagery data.

59. The computing apparatus of claim 52, wherein classifying the objects in the programmed method includes applying an image analysis engine to a knowledge rules base to operate on the dynamic data.

60. The computing apparatus of claim 52, wherein the programmed method further comprises at least one of:
exporting the dynamic mobility map in a terrain database format;
reading the overhead imagery data from a storage;
merging the classified objects with a digital elevation map;
acquiring the dynamic data;
navigating a vehicle;
simulating the navigation of a vehicle; and
rehearsing a mission scenario.

61. A method for use in association with a ground vehicle, comprising:
generating a dynamic mobility map of a terrain to be traversed, including:
classifying a plurality of objects represented in a data set comprised of overhead imagery data through application of dynamic data pertaining to those objects; and
planning a route across the terrain, including:
acquiring a set of mission parameters;
planning a route from the classification of objects in a dynamic mobility map derived from dynamic data in light of the acquired mission parameters and a position; and
presenting the route to an operator.

62. The method of claim 61, wherein classifying the includes:
updating the overhead imagery data with change data prior to beginning the classification; and
classifying the objects through the updated overhead imagery data.

63. The method of claim 61, wherein classifying the includes applying an image analysis engine to a knowledge rules base to operate on the overhead imagery data.

64. The method of claim 61, wherein classifying the objects includes applying an image analysis engine to a knowledge rules base to operate on the dynamic data.

65. The method of claim 61, further comprising at least one of:
exporting the dynamic mobility map in a terrain database format;
reading the overhead imagery data from a storage;
merging the classified objects with a digital elevation map;
acquiring the dynamic data;
navigating a vehicle;
simulating the navigation of a vehicle; and
rehearsing a mission scenario.

66. The method of claim 61, wherein acquiring the mission parameters includes at least one of receiving the mission parameters from the operator, receiving the mission parameters broadcast from another location, and receiving mission parameters downloaded prior to deployment.

67. The method of claim 61, wherein planning the route includes planning a route in light of threat information.

68. The method of claim 61, wherein presenting the route to the operator includes presenting the route through a computer implemented operator interface.

69. The method of claim 61, wherein presenting the route to the operator includes presenting a two-dimensional display to the operator.

70. The method of claim 61, further comprising one of:
receiving an indication of whether the route has been accepted;
transmitting the route for implementation upon receiving an indication that the route has been accepted; and
planning an alternative route upon receiving an indication that the route has not been accepted.

71. The method of claim 61, further comprising one of:
operating the ground vehicle; and
simulating the operation of the ground vehicle.

72. The method of claim 71, wherein simulating the operation of the ground vehicle includes simulating the operation of the ground vehicle in accordance with a mission rehearsal scenario.
